(19) United States
(12) Patent Application Publication
(10) Pub. No.: US 2025/0013438 A1
(43) Pub. Date: Jan. 9, 2025

(54) SCRIPT EDITOR FOR ROUTINE CREATION

(71) Applicant: Google LLC, Mountain View, CA (US)

(72) Inventors: Michael Andrew Goodman, Mountain View, CA (US); Deepak Goyal, Mountain View, CA (US)

(73) Assignee: Google LLC, Mountain View, CA (US)

(21) Appl. No.: 18/746,997

(22) Filed: Jun. 18, 2024

Related U.S. Application Data
(60) Provisional application No. 63/511,910, filed on Jul. 5, 2023.

(51) Int. Cl. G06F 8/35; G06F 8/34; G10L 13/08; G10L 15/22

(52) U.S. Cl. CPC G06F 8/35; G06F 8/34; G10L 13/08; G10L 15/22

(57) ABSTRACT

A method include receiving a natural language prompt from a user comprising a command to generate a code script for an automated assistant to perform a routine. The routine includes multiple discrete actions specified by the natural language prompt. The method further includes processing, by a pre-trained large language model (LLM), the natural language prompt to generate the code script as an LLM output, and processing the code script to determine the code script is incomplete, thereby rendering the code script unsuitable for the automated assistant to fulfill performance of the routine. Based on determining the code script is incomplete, the method includes issuing a user prompt soliciting the user to provide additional information needed to complete the code script and receiving user input of the additional information needed to complete the code script. The method includes supplementing the code script with the additional information to render completed code script.

### CROSS-REFERENCE TO RELATED APPLICATIONS

This U.S. patent application claims priority under 35 U.S.C. § 119 (e) to U.S. Provisional Application 63/511,910, filed on Jul. 5, 2023. The disclosure of this prior application is considered part of the disclosure of this application and is hereby incorporated by reference in its entirety.

### TECHNICAL FIELD

This disclosure relates to a script editor for routine creation.

### BACKGROUND

Automated assistants (also known as “personal assistant modules”, “mobile assistants”, “digital assistants”, or “chat bots”) may be interacted with by a user via a variety of computing devices, such as smart phones, tablet computers, wearable devices, automobile systems, standalone personal assistant devices, and so forth. The automated assistants receive input from the user (e.g., typed and/or spoken natural language input) and respond with responsive content (e.g., visual and/or audible natural language output).

Automated assistants can perform a routine of multiple actions in response to, for example, receiving a particular command (e.g., a shortcut command). For example, in response to receiving a spoken utterance of “Good Night”, an automated assistant can cause a sequence of actions to be performed, such as causing networked lights to be turned off, tomorrow's weather forecast to be rendered, and a user's agenda for tomorrow to be rendered. An automated assistant routine can be particularized to a user and/or to an ecosystem of client devices, and the user can be provided control to manually add certain actions to certain routines.

Large language models (LLMs) that generate text in response to a user input are becoming increasingly popular as generative artificial intelligence (AI) grows in popularity. Certain LLMs are pre-trained to generate code recommendations from contextual information

### SUMMARY

One aspect of the disclosure provides a computer-implemented method that when executed on data processing hardware causes the data processing hardware to perform operations that include receiving a natural language prompt from a user comprising a command to generate a code script for an automated assistant to perform a routine. The routine includes multiple discrete actions specified by the natural language prompt. The operations further include processing, by a pre-trained large language model (LLM), the natural language prompt to generate the code script as an LLM output, and processing the code script generated by the pre-trained LLM to determine the code script is incomplete, thereby rendering the code script unsuitable for the automated assistant to fulfill performance of the routine. Based on determining the code script is incomplete, the operations include issuing a user prompt soliciting the user to provide additional information needed to complete the code script and receiving user input of the additional information needed to complete the code script. The operations also include supplementing the code script with the additional information to render completed code script. The completed code script is rendered suitable for the automated assistant to fulfill performance of the routine when triggered by an initiator for the routine.

In some implementations, the operations also include processing the code script generated by the pre-trained LLM to identify the multiple discrete actions to be performed by the automated assistant to fulfill the routine and presenting, for output in a graphical user interface displayed on a screen of a user device associated with the user, corresponding graphical representations for the multiple discrete actions identified for the automated assistant to perform to fulfill the routine. Here, selection of a corresponding one of the graphical representations presented for display in the graphical user interface may cause the GUI to present options for editing the discrete action corresponding to the graphical representation selected by the user.

In some examples, processing the code script generated by the pre-trained LLM to determine the code script is incomplete includes identifying a presence of an ambiguity in the code script and issuing the user prompt includes issuing the user prompt to solicit the user to provide additional information to resolve the ambiguity identified in the code script. Additionally or alternatively, processing the code script generated by the pre-trained LLM to determine the code script is incomplete may include determining that the code script includes a slot that lacks a fixed value and issuing the user prompt may include issuing the user prompt to solicit the user to provide additional information that includes the fixed value for the slot in the code script that lacked the fixed value. In yet an addition example, processing the code script generated by the pre-trained LLM to determine the code script is incomplete includes determining that the code script fails to convey the initiator for the routine and issuing the user prompt includes issuing the user prompt to solicit the user to provide additional information that includes the initiator for the routine.

In some implementations, issuing the user prompt includes generating, using a text-to-speech engine, synthesized speech of an utterance requesting the user to provide the additional information and engaging a dialog with the user via the user device by instructing the user device to audibly output the synthesized speech of the utterance requesting the user to provide the additional information. Here, receiving the user input of the additional information may include receiving audio data characterizing the additional information spoken by the user.

In some examples, issuing the user prompt includes generating a graphical representation for output from a user device associated with the user that solicits the user to provide the additional information. Receiving the natural language prompt may include receiving audio data characterizing an utterance of the natural language prompt spoken by the user.

In some implementations, the operations also include obtaining a set of user features associated with the user and determining, using the set of user features associated with the user, a user prompt embedding for the user. In these implementations, processing the natural language prompt to generate the code script as the LLM output includes processing, by the LLM, the natural language prompt conditioned on the user prompt embedding for the user to generate the code script as the LLM output. In these implementations, the set of user features associated with the user may include at least one of user preferences, past interactions between the user and the automated assistant, or available peripheral devices associated with the user and capable of receiving commands from the automated assistant to perform actions. Here, the user prompt embedding may include a soft prompt configured to guide the LLM to generate the code script while parameters of the LLM are held fixed.

In some examples, a training process trains the LLM by receiving a training dataset of training routines, wherein each training routine include a corresponding training natural language prompt specifying one or more discrete actions for an automated assistant routine, and corresponding ground-truth code script paired with the corresponding training natural language prompt. In these examples, for each training routine in the dataset, the training process also includes processing, using the LLM, the corresponding training natural language prompt to generate a corresponding predicted code script for the routine as output from the LLM and determining a training loss based on the corresponding predicted code script and the corresponding ground-truth code script paired with the corresponding training natural language prompt. The training process also includes training the LLM to learn how to predict the ground-truth code scripts from the corresponding training natural language prompts based on the training losses determined for the training routines in the training dataset. In these examples, each training routine may further include a corresponding training user prompt embedding generated from a corresponding set of training user features, and processing the corresponding training natural language prompt may include processing, using the LLM, the corresponding training natural language prompt condition on the corresponding training user prompt embedding to generate the corresponding predicted code script for the routine as output from the LLM.

A system includes data processing hardware and memory hardware in communication with the data processing hardware and storing instructions that when executed on the data processing hardware causes the data processing hardware to perform operations that include receiving a natural language prompt from a user comprising a command to generate a code script for an automated assistant to perform a routine. The routine includes multiple discrete actions specified by the natural language prompt. The operations further include processing, by a pre-trained large language model (LLM), the natural language prompt to generate the code script as an LLM output, and processing the code script generated by the pre-trained LLM to determine the code script is incomplete, thereby rendering the code script unsuitable for the automated assistant to fulfill performance of the routine. Based on determining the code script is incomplete, the operations include issuing a user prompt soliciting the user to provide additional information needed to complete the code script and receiving user input of the additional information needed to complete the code script. The operations also include supplementing the code script with the additional information to render completed code script. The completed code script is rendered suitable for the automated assistant to fulfill performance of the routine when triggered by an initiator for the routine.

In some implementations, the operations also include processing the code script generated by the pre-trained LLM to identify the multiple discrete actions to be performed by the automated assistant to fulfill the routine and presenting, for output in a graphical user interface displayed on a screen of a user device associated with the user, corresponding graphical representations for the multiple discrete actions identified for the automated assistant to perform to fulfill the routine. Here, selection of a corresponding one of the graphical representations presented for display in the graphical user interface may cause the GUI to present options for editing the discrete action corresponding to the graphical representation selected by the user.

In some examples, processing the code script generated by the pre-trained LLM to determine the code script is incomplete includes identifying a presence of an ambiguity in the code script and issuing the user prompt includes issuing the user prompt to solicit the user to provide additional information to resolve the ambiguity identified in the code script. Additionally or alternatively, processing the code script generated by the pre-trained LLM to determine the code script is incomplete may include determining that the code script includes a slot that lacks a fixed value and issuing the user prompt may include issuing the user prompt to solicit the user to provide additional information that includes the fixed value for the slot in the code script that lacked the fixed value. In yet an addition example, processing the code script generated by the pre-trained LLM to determine the code script is incomplete includes determining that the code script fails to convey the initiator for the routine and issuing the user prompt includes issuing the user prompt to solicit the user to provide additional information that includes the initiator for the routine.

In some implementations, issuing the user prompt includes generating, using a text-to-speech engine, synthesized speech of an utterance requesting the user to provide the additional information and engaging a dialog with the user via the user device by instructing the user device to audibly output the synthesized speech of the utterance requesting the user to provide the additional information. Here, receiving the user input of the additional information may include receiving audio data characterizing the additional information spoken by the user.

In some examples, issuing the user prompt includes generating a graphical representation for output from a user device associated with the user that solicits the user to provide the additional information. Receiving the natural language prompt may include receiving audio data characterizing an utterance of the natural language prompt spoken by the user.

In some implementations, the operations also include obtaining a set of user features associated with the user and determining, using the set of user features associated with the user, a user prompt embedding for the user. In these implementations, processing the natural language prompt to generate the code script as the LLM output includes processing, by the LLM, the natural language prompt conditioned on the user prompt embedding for the user to generate the code script as the LLM output. In these implementations, the set of user features associated with the user may include at least one of user preferences, past interactions between the user and the automated assistant, or available peripheral devices associated with the user and capable of receiving commands from the automated assistant to perform actions. Here, the user prompt embedding may include a soft prompt configured to guide the LLM to generate the code script while parameters of the LLM are held fixed.

In some examples, a training process trains the LLM by receiving a training dataset of training routines, wherein each training routine include a corresponding training natural language prompt specifying one or more discrete actions for an automated assistant routine, and corresponding ground-truth code script paired with the corresponding training natural language prompt. In these examples, for each training routine in the dataset, the training process also includes processing, using the LLM, the corresponding training natural language prompt to generate a corresponding predicted code script for the routine as output from the LLM and determining a training loss based on the corresponding predicted code script and the corresponding ground-truth code script paired with the corresponding training natural language prompt. The training process also includes training the LLM to learn how to predict the ground-truth code scripts from the corresponding training natural language prompts based on the training losses determined for the training routines in the training dataset. In these examples, each training routine may further include a corresponding training user prompt embedding generated from a corresponding set of training user features, and processing the corresponding training natural language prompt may include processing, using the LLM, the corresponding training natural language prompt condition on the corresponding training user prompt embedding to generate the corresponding predicted code script for the routine as output from the LLM.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is an example system leveraging a large language model to generate code script for an automated assistant routine from a natural language prompt.

FIG. 2 is a schematic view of example components of an automated assistant.

FIG. 3 is a schematic view of an example training processes for training the large language model of FIG. 1 to generate code scripts.

FIG. 4 is a flowchart of an example arrangement of operations for a method of generating code script for automated assistant routines from natural language prompts

FIG. 5 is a schematic view of an example computing device that may be used to implement the systems and methods described herein.

Like reference symbols in the various drawings indicate like elements.

### DETAILED DESCRIPTION

Automated assistant routines can be initiated in response to detecting a shortcut command in spoken or typed user interface input of a user, initiated in response to user interaction with a virtual or hardware element at a client device, initiated in response to detecting a user gesture, and/or initiated in response to other abbreviated user interface input(s). Abbreviated user interface inputs for initiating an automated assistant routine are abbreviated in that they require less user input, and/or less processing of the user input, than would otherwise be needed to cause performance of the actions of the automated assistant routine, but for the abbreviated user input. For example, a shortcut command that causes performance of an automated routine of a sequence of actions can be abbreviated in that it is shorter in length than the commands that would otherwise need to be spoken/typed, but for the condensed command, to cause the automated assistant to perform the set of actions. Various automated assistant routines can additionally or alternatively be initiated automatically upon the occurrence of one or more conditions, and optionally without requiring explicit user interface input. Such automatic initiation of an automated assistant routine can also require less user input and/or less processing of the user input, than would otherwise be needed to cause performance of the actions of the automated assistant routine.

While initiating an automated assistant routine is well-established, creating a custom automated assistant routine of a sequence of actions to be performed by an automated assistant remains a cumbersome process for end users. The steps a user must take to create the custom automated assistant routine vary, but generally require the user configure the routine via a graphical user interface by providing a user input to create a new automated assistant routine, name the new automated assistant routine, and then provide a corresponding user input to manually add each action in the sequence of actions for the custom assistant routine. Here, in response to providing the corresponding user input indicating that a new action is to be added to the routine, the graphical user interface will first present a list of action categories for the user to select from, and then upon selecting one of the action categories, require the user to scroll through a list of available actions from the selected category and select the action the user wants to add to the custom automated assistant routine. This process repeats for each action in the sequence of actions the user wants to add to the custom automated assistant routine. In other words, when a user thinks of actions he/she would like performed as part of a morning routine, not only does the user have to go through the list of actions and manually select each action the user wants to add to the routine, but the actions the user wants the automated assistant to perform must also be “available” for the user to select. Notably, as the available actions are pre-populated, they are essentially curated by developers and each available action is paired with corresponding code script in a target computing language written by the developer. Thus, the automated assistant performs the custom assistant routine by executing the underlying code script paired with each corresponding action in the sequence of actions for the automated assistant routine.

To the extent that conventional techniques for creating automated assistant routines permit users to add only actions that are available and paired with corresponding code script created by a developer when creating an automated assistant routine, the automated assistant routine is only “custom” in the sense that the combination of available actions manually added by the user to form the routine are custom. That is, these conventional techniques for creating automated assistant routines lack the ability to truly allow the user to create custom actions, or even create custom conditions for invoking actions, since code script must be written for these custom actions in the required code language for the digital assistant to execute. For instance, consider a user who would like a morning routine to be performed by a digital assistant that includes the actions of conveying the current day's weather forecast from a smart speaker, brewing a cup of coffee from the user's smart coffee machine, and starting the user's car when the user removes the cup of coffee from the coffee machine. Notably, the user wants his/her car to be started and running for only a period of time sufficient to for an interior to reach a comfortable temperature, which the user deems is about the time it takes the user to drink his or her coffee. Otherwise, starting the car at the same time the brewing the coffee commences and the current day's weather forecast is being recited, would be too premature requiring the car to remain running for a longer time than necessary. While initiating the automated assistant to commence reciting the weather forecast and brewing of the coffee are typical actions for which code script exists, the condition to only start the user's car upon removal of the cup of coffee from the smart coffee machine is unique to the user and likely does not already have underlying code script. Intuitively, an example underlying code script for the condition to start the user's car upon removal of the cup of coffee would include an instruction that triggers the smart coffee machine to notify the automated assistant when a cup detection/placement sensor of the smart coffee machine detects when the cup is removed after the coffee was brewed and dispensed into the cup. The underlying code script would also include another instruction that causes the automated assistant to command an ignition interface (i.e., which could include a cloud-based access point associated with a manufacturer of the vehicle for remotely starting the vehicle, or a direct access point of the vehicle that can interface with the automated assistant) to start the car when the notification is received from the smart coffee machine.

Implementations herein are directed toward leveraging large language models (LLMs) to generate code scripts for executing automated assistant routines based on natural language prompts input by users. In some examples, the large language model (LLM) is trained on a training dataset of training natural language prompts each specifying a sequence of actions for an automated assistant routine and paired with corresponding ground-truth code script. In these examples, the LLM may be initially trained on the training data set to teach the LLM to generate the corresponding ground-truth code script. Alternatively, an existing pre-trained LLM may be fine-tuned on the training data set to teach the LLM to generate the corresponding ground-truth code script. As such, the ground-truth code script paired with each training natural language prompt in the training data set corresponds to an LLM output the LLM is being trained to generate. Notably, the vocabulary/sequence length of predicted LLM outputs generated by the LLM during training/fine-tuning may be restricted to match the vocabulary/sequence length of the ground-truth code scripts.

The ground-truth code script paired with each training natural language prompt may include multiple respective portions of code script each associated with a respective discrete action among the multiple discrete actions specified by the training natural language prompt. That is, each respective portion of the ground-truth code script, when executed, is configured to cause the automated assistant to perform the respective discrete action specified by the training natural language prompt. Moreover, the LLM may be trained or fine-tuned to generate code scripts in multiple discrete different programming languages for a same natural language prompt. As such, one or more of the training natural language prompts in the training dataset may each be paired with two or more ground-truth code scripts each associated with a different respective ground-truth code script for executing the underlying sequence of discrete actions for the automated assistant routine to perform as specified by the corresponding training natural language prompt. Example programming languages for the code scripts may include, without limitation, C++, Java, Javascript, Python, Go, Carbon, Sawazal, Swift, Ruby, PowerShell.

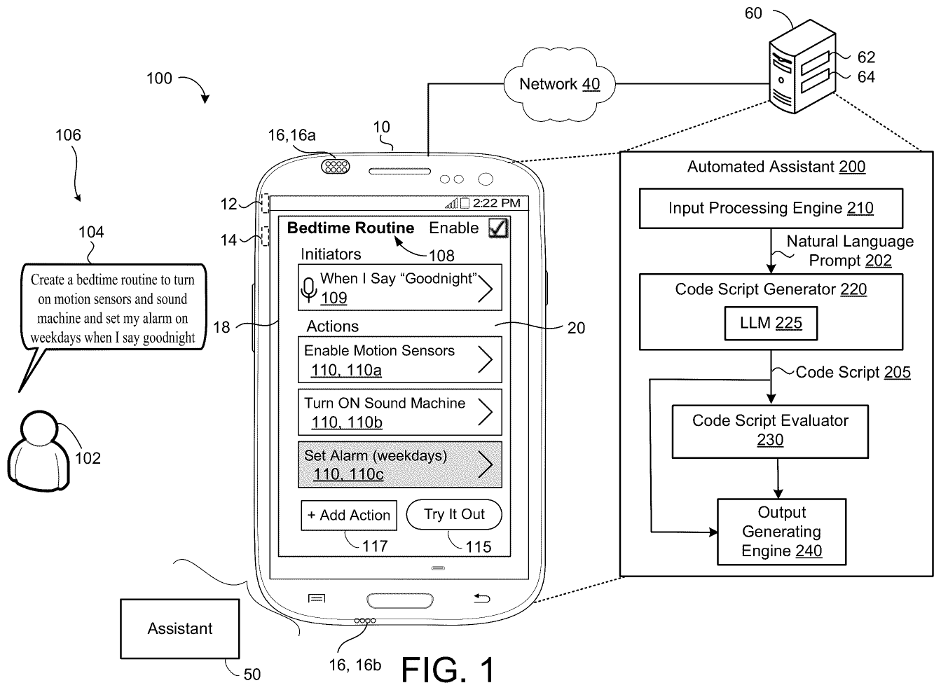

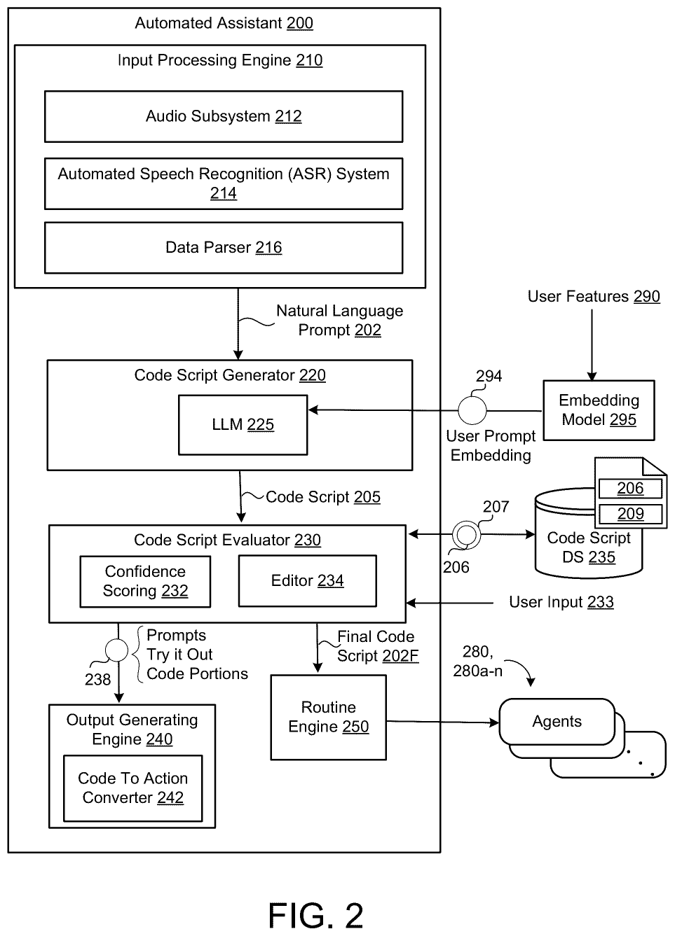

Referring to FIGS. 1 and 2, an example system 100 includes an automated assistant 200 executing on a user device 10 and/or a remote system 60 in communication with the user device 10 via a network 40. The user device 10 and/or the remote system 60 executes the automated assistant 200 that a user 102 may interact with through speech, textual inputs, and/or spatial inputs to perform a sequence of actions for an automated assistant routine. For instance, the user 102 may speak or type a shortcut command that causes performance of an automated routine of a sequence of actions, whereby the shortcut command is abbreviated in that it is shorter in length than the commands that would otherwise need to be spoken/typed, but for the condensed command, to cause the automated assistant to perform the set of actions generate code script for execution to perform a sequence of actions for an automated assistant routine. automated assistant 200. Additionally or alternatively, performance of an automated assistant routine can be initiated automatically upon the occurrence of one or more conditions, and optionally without requiring explicit user interface input.

In the example shown, the user device 10 corresponds to a smart phone, however the user device 10 can include other computing devices having, or in communication with, display screens, such as, without limitation, a tablet, smart display, desktop/laptop, smart watch, smart appliance, smart glasses/headset, or vehicle infotainment device. The user device 10 includes data processing hardware 12 and memory hardware 14 storing instructions that when executed on the data processing hardware 12 cause the data processing hardware 12 to perform operations. The remote system 60 (e.g., server, cloud computing environment) also includes data processing hardware 62 and memory hardware 64 storing instructions that when executed on the data processing hardware 62 cause the data processing hardware 62 to perform operations. As described in greater detail below, the automated assistant 200 includes a code script generator 220 that leverages a large language model (LLM) 225 for generating code script 212 to execute a custom automated assistant routine of multiple discrete actions specified by a natural language prompt 202 input by the user 102. In some examples, code script generator 220 and LLM 225 execute on the remote system 60. In other examples, the code script generator 220 and LLM 225 execute on the user device 10. Optionally, the code script generator 220 and LLM 225 may be shared across the user device 10 and the remote system 60.

The user device 10 further includes an audio system 16 with an audio capture device (e.g., microphone) 16, 16a for capturing and converting spoken utterances 104, within the environment into electrical signals and an audio output device (e.g., a speaker) 16, 16b for communicating an audible audio signal (e.g., as output audio data from the device 10). While the user device 10 implements a single audio capture device 16a in the example shown, the user device 10 may implement an array of audio capture devices 16a without departing from the scope of the present disclosure, whereby one or more capture devices 16a in the array may not physically reside on the user device 10, but be in communication with the audio system 16. The user device 10 also executes, for display on a screen 18 in communication with the data processing hardware 12, a graphical user interface (GUI) 20 configured to capture user input indications via any one of touch, gesture, gaze, and/or an input device (e.g., mouse, trackpad, or stylist) for controlling functionality of the user device 10. The GUI 20 may be an interface associated with an assistant interface 50 executing on the user device 10 that the user 102 interacts with to communicate with the automated assistant 200.

The input processing engine 210 includes an audio subsystem 212 configured to receive streaming audio 107 of an utterance 104 spoken by the user 102 (i.e., captured by the microphone 16a) and convert the utterance 104 into a corresponding digital format associated with input acoustic frames 110 capable of being processed by an automated speech recognition (ASR) system 214. In the example shown, the user speaks a respective utterance 104 in a natural language of English for the phrase “Create a bedtime routine to turn on motion sensors and sound machine, and also set my alarm on weekdays when I say goodnight” and the audio subsystem 108 converts the streaming audio of the utterance 104 into corresponding acoustic frames for input to the ASR system 214. Thereafter, the ASR system 214 generates/predicts, as output, a corresponding transcription (e.g., recognition result/hypothesis) of the utterance 104 that corresponds to a natural language prompt 214. Optionally, the user 102 may input (e.g., via the GUI) text conveying the natural language prompt 214 instead of speaking. The text of the natural language prompt 214 can be parsed by a data parser and a natural language understanding (NLU) module processes the parsed to text to determine that the natural language prompt 214 corresponds to a command to create a custom routine of a set of actions for the automated assistant 200 to perform when an initiation condition is satisfied. In the example, the natural language prompt 214 specifies the name of the routine as “Bedtime” and defines the initiation condition as the spoken phrase “Goodnight”. Notably, the natural language prompt specifies multiple discrete actions: a first action to turn on motion sensors; a second action to turn on a sound machine; and a third action to set alarm on weekdays.

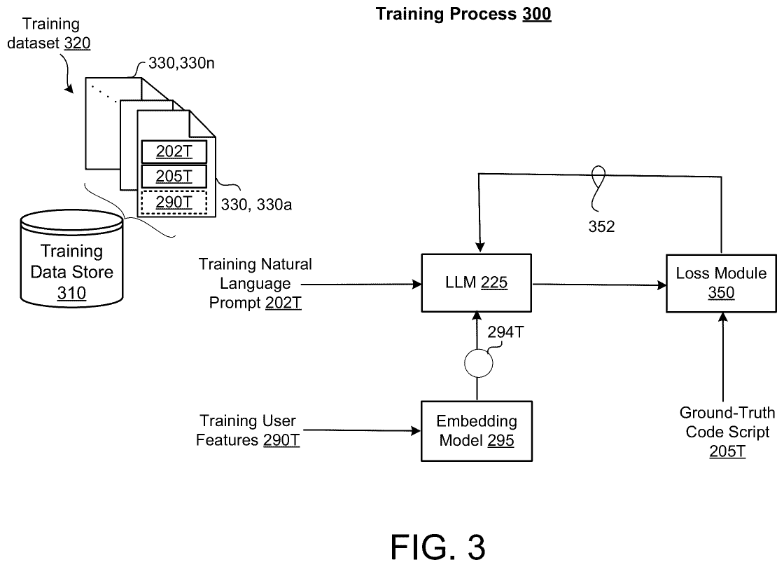

Based on determining that the natural language prompt 214 corresponds to the command to create the custom routine, the parsed text of the natural language prompt 214 is provided to the code script generator 225 to generate corresponding code script 214 for executing the discrete actions of the routine specified by the natural language prompt 214. The code script 214 also includes respective code indicating the name of the routine (Bedtime) as well as respective code defining initiation conditions for triggering the automated assistant 200 to perform the routine. More specifically, the LLM 220 is configured to receive the natural language prompt 214, as input, and generate, as an LLM 220 output, the code script 214 in one or more different programming languages. As described in greater detail below with reference to FIG. 3, the LLM 220 may be trained and/or fine-tuned on a training dataset 310 (FIG. 3) of training natural language prompts 312 (FIG. 3) each specifying a sequence of actions for an automated assistant routine and paired with corresponding ground-truth code script 314 (FIG. 3). As such, the LLM 220 may be restricted to generate code scripts 214 with a vocabulary/sequence length that match the vocabulary/sequence length of the ground-truth code scripts 314 in the training dataset 310.

A code script evaluator 230 evaluates the code script 205 generated by the LLM 225 to determine whether the code script 205 is complete and a confidence that the code script 205 accurately represents the custom routine 108 the user 102 intended to create as specified by the natural language prompt 202. The code script evaluator 230 may determine the code script 205 is complete when the code script 205 satisfies conditions required for execution by the automated assistant 200. The underlying code script 205 may include multiple respective portions of code script each associated with a respective discrete action 110 among multiple discrete actions 110, 110a-c to be performed by the automated assistant 200 to fulfill the routine 108 the user 110 intended to create from the natural language prompt 202. The conditions required for executing the code script 205 by the automated assistant 200 may include determining at least one of a programming language of the code script 205 is in a programming language compatible with the automated assistant, a confidence of each respective peripheral device identified as necessary to perform a corresponding one of the discrete actions 110, availability of each respective peripheral device identified as necessary to perform corresponding ones of the discrete actions, the code script 225 specifies an initiator for invoking the automated assistant 200 to perform the routine 108, or all slots in the code script 225 include fixed values. In some examples, one or more of the peripheral devices include internet-of-things (IoT) devices such as smart speakers, smart displays, smart appliances, smart phones, tablets, wearables, etc. One of the peripheral devices may include the user device 10.

As used herein, a peripheral device is required for the custom routine 108 if one or more of the discrete actions 110 result in a state of the peripheral device being altered. In some implementations, a user can is associated with a peripheral device when the peripheral device has been “discovered” by the automated assistant 200 and can be controlled by the automated assistant 200. In some implementations, a user is associated with a peripheral device if user input and/or one or more network packets indicate presence of the peripheral device, even if the peripheral device has not yet been explicitly “discovered” by the automated assistant 200

The output generating engine 240 presents instances of output to the user device 10. An instance of output can be, one or more initiation conditions specified by the code script 225 for invoking the automated assistant to perform the routine 108, a list of the discrete actions 110 conveyed by the code script 225 and to be performed by the automated assistant 200 to fulfill the routine 108, a prompt requesting the user to provide additional information (e.g., fixed values for slots in the code script 225 that lack fixed values) to complete the code script 225, and an option to “try out” executing each of the multiple discrete actions of the routine. In some examples, the LLM 225 tags/annotates portions of the code script 225 that includes slots that lack fixed values, and that must be resolved in order to fulfill the routine. The code script evaluator 230 may identify the tagged/annotated portions of the code script 225 that include slots lacking fixed values. Optionally, the code script evaluator 230 may process the code script 225 and identify slots where fixed values are missing without the LLM 225 explicitly tagging/annotating lines of code where fixed values are missing. The output generating engine 240 may generate graphical and/or audible representations of the instances of output to the user device 10. For instance, the output generating engine 240 may include a text-to-speech engine than generates synthesized speech that engages a dialog with the user by prompting the user for a fixed value, e.g., “What time do you want your alarm set for on weekdays?” By the same notion, graphical or audible prompts may prompt the user to disambiguate between two peripheral devices available to perform an action, e.g., “I was unable to discover a sound machine, would you like the bedroom speaker to play white noise to simulate a sound machine?”

In the example shown in FIG. 1, the output generating engine 240 prevents graphical representations for display in the GUI 20 that indicate the name (Bedtime) of the custom routine 108, one or more initiators 109 for initiating the routine 108, each discrete action 110, 110a-c for the automated assistant 200 to perform for fulfilling the routine 108, an optional graphical button 115, that when selected by the user 102, will cause automated assistant to execute the code script 205 to perform each of the discrete actions 110. The user 102 may choose to edit/modify one or more actions 110 after automated assistant 200 executes the code script 205. In some scenarios, selection of the graphical button 115 causes the automated assistant 200 to virtually perform the discrete actions 110 by presenting a simulation of each action the automated assistant 200 will perform for the routine 108 from execution of the code script 205 generated from the natural language prompt 202. The simulation presented by the automated assistant 200 could include an audible message that describes each corresponding action 110 the automated assistant 200 will perform, any peripheral devices involved with the corresponding action 110, and under what conditions the action 110 will be performed. Additionally or alternatively, the simulation presented by the automated assistant 200 may include a graphical simulation (e.g., a video or diagram) that depicts the actions 110 the automated assistant 200 will perform. Notably, the output generating engine 240 configures the GUI 20 of the user device 102 to display these graphical representations based on the natural language prompt 202 input by the user 102 and the resulting code script 205 generated by the code script generator 220. In some examples, the code script evaluator 230 instructs the output generating engine 240 to display the graphical button 115 when a confidence of the code script fails to satisfy a confidence threshold. In these examples, the output generating engine 240 may omit display of the graphical button 115 when the confidence of the code script 205 satisfies the confidence threshold. The user 102 may also select a graphical button 117 if the user 102 would like to add an additional action 110 for the automated assistant to perform as part of the custom routine 200. For instance, the user 102 may realize that he/she forgot to include that the user 102 would like all the doors locked in his/her house as part of the bedtime routine 108 when the user spoke the utterance 104 conveying the natural language prompt 202.

Continuing with the example of FIG. 1, the user 102 may interact with the GUI 20 to edit the bedtime routine 108 created by the automated assistant 200 from the natural language prompt 200. For instance, the graphical representation for the imitators 109 may convey that the Bedtime Routine 108 is to be initiated when the user 102 speaks “Goodnight”. If the user 102 decides that he/she would like to change the invocation phrase, include additional invocation phrases (e.g., “Bed time” or “Nighty-night) for invoking the bedtime routine 108, and/or add conditions for invoking the bedtime routine without any explicit input from the user (e.g., setting a time of day as one of the initiators 109), the user may select the graphical representation of the initiators 109 which will cause the GUI 20 to present options for making changes to the initiators. The graphical representations for each corresponding discrete action 110 of the multiple discrete actions 110 for the routine 108 may each include a brief description of the underling action the automated assistant 200 will perform. Notably, the output generating engine 240 may ascertain the description of each discrete action 110 in natural language text from a respective portion of the code script 205 generated by the code script generator 230. For instance, FIG. 2 shows the output generating engine 240 including a code to action converter 242 tasked with converting the respective portions of the code script in a programming language into natural language descriptions conveying the respective actions 110. Referring back to FIG. 1, the user 102 may select the graphical representation of any discrete action 110 that the user 102 would like to edit. Selection of a graphical representation of a corresponding action 110 may cause the GUI 20 to present options for editing the corresponding action 110. For instance, the user may select the enable motion sensors action 110a and have the option to enable/disable specific ones or groups of motion sensors dispersed through the user's home. In some implementations, the output generating engine 240 augments the graphical representations for any actions 110 that cannot be performed by the automated assistant 200 until the user 10 provides additional information. In the example shown, the graphical representation for the Set Alarm discrete action 110c is augmented (e.g., shaded) due to the code script evaluator 230 (and/or the code script generator 220) determining that a slot associated with a time of the alarm is missing a fixed value. Here, the user may select the graphical representation and the GUI 20 may prompt the user 10 to input the time the user would like to set the alarm. The user 10 may also have the ability to specify which peripheral devices should sound the alarm.

FIG. 2 shows additional details of the automated assistant 200 for creating the custom routine 108 from the natural language prompt 202 input by the user 10. In some implementations, the automated assistant 200 further obtains a set of user features 290 associated with the user 10 and processes, using a user embedding model 295, the set of user features 290 to generate a user prompt embedding 294 for the user 10. Here, the set of user features 290 associated with the user may include at least one of user preferences, user settings, past interactions between the user and the automated assistant 200, or available peripheral devices associated with the user and capable of receiving commands from the automated assistant to perform actions. In these implementations, the LLM 225 generate the code script 225 from the natural language prompt 202 by processing the natural language prompt 202 conditioned on the user prompt embedding 294 generated for the user 10. In some scenarios, the user prompt embedding 294 includes a soft prompt configured to guide the LLM to generate the code script while parameters of the LLM are held fixed.

In some examples, the code script evaluator 230 includes a confidence scorer 232 that determines a confidence score for the code script 205 generated by the LLM 225 indicating a confidence that the code script 205 accurately conveys the custom routine 108 specified by the natural language prompt 202. The confidence scorer 232 may determine the confidence score based on whether or not the resulting code script 202 is for a routine 108 typically encountered by the LLM 225. For instance, a higher confidence score would result when the code script 202 matches or is substantially similar to code scripts 202 previously generated by the LLM 225 for the user and/or similar to code scripts the LLM encountered during training/fine tuning.

In some scenarios, when the LLM 225 is unable to generate portions of the code script 205 for unique actions or from natural language prompts 202 not similar to prompts seen during training, the code script evaluator 230 may retrieve code script segments 206 from a code script data store 235. Here, the code script data store 235 may store a corpus of code scripts segments 206 extracted from code scripts for routines created from natural language prompts from a population of other users. Here, each code script segment 206 may be paired with a corresponding natural language prompt embedding 209. For instance, other users may submit their own natural language prompts for the LLM to generate code scripts for performing custom routines. These code scripts are verified as final code scripts once enabled for execution and modified as necessary, and the corresponding natural language prompts may be encoded into embeddings 209 and represented in an embedding space. As such, the code script evaluator 230 may generate an embedding 207 of the natural language prompt 202 input by the user 10 and query the code script datastore 235 using the embedding 207 to retrieve code script segments 206 from the code script datastore 235 that are paired with corresponding natural language prompt embeddings 209 that are within a threshold distance from the embedding 207 in the embedding space. For instance, the threshold distance may be based on a cosine similarity between the embedding 207 and each natural language prompt embeddings 209, whereby the code script segments 206 associated with embeddings 209 having cosine similarities from the embedding 208 that satisfy the threshold distance are retrieved by the code script evaluator 230. Here, the code script evaluator 230 may use the retrieved code script segments 206 to resolve any ambiguities in the code script 205, replace one or more portions of the code script 205, verify an accuracy of the code script 205, or supplement the code script 205 in other ways. Ambiguities in the code script 205 may include identification of conflicts between two or more actions 110 in the code script or with other actions in another routine associated with the user. Ambiguities in the code script 205 may also include two or more possible parameters for a given slot in the code script 205 such as, but not limited to two or more peripheral devices capable of performing a respective action 110, two or more contacts associated with a respective action, two or more possible times associated with a respective action, or two or more possible conditions associated with invoking a respective action.

In some examples, the embeddings 207 in the code script data store 235 are generated from segments of natural language prompts from other users that each define/specify a corresponding discrete action or initiator for a routine, whereby the corresponding code script segment 206 paired with each of embedding 207 includes the underlying code for performing the corresponding discrete action or initiator defined/specified by the segment of the natural language prompt. In these examples, the code script evaluator 230 may segment the natural language prompt into discrete segments that each define a corresponding initiator or discrete action, and then generate respective embeddings 207 for the segments of the natural language prompt that the code script evaluator 230 may use to query the code script datastore 235 for retrieving relevant code script segments 206 associated with routines created by users from the population of users.

The code script evaluator 230 also includes an editor 234 to enable post-editing of the code script 205 generated by the LLM 225. The code script 205 may be generated in response to user input 233 such as the user 10 editing discrete actions 110 via selection of the graphical representation of any of the actions 110 displayed in the GUI 20 of FIG. 1. For instance, the user input 233 may indicate edits that change/modify any of the invocators 109 and/or change/modify the actions 110 such as input of fixed values for slots that lack fixed values or for slots that included incorrect values. In additional implementations, the editor 234 receives a user input 233 in response to a prompt requesting the user 10 to provide additional information that is missing from the code script 205, resolve an ambiguity found in the code script 205, and/or to provide fixed values for any slots that lack fixed values. Here, the user input 233 may be a spoken input confirming a prompt issued by the assistant 205, a textual input, or based on interactions with the GUI 20. Notably, the user 10 need not make edits to the actual code script 205, but instead, may provide user inputs 233 via natural language and/or interacting with the GUI 20 such that the editor 234 can edit the underlying code script 205 via an assistant interface based on the user inputs 233. The user input 233 may also be received when the user 10 enables the routine 108 to run, e.g., via selection of an enable button displayed in the GUI 20 of FIG. 1. Optionally, the GUI 20 may display the code script 205 and permit the user 10 to make edits to the lines of code as necessary.

The code script evaluator 230 may provide output instances 238 to the output generating engine 240. The output instances 238 may include any prompts the automated assistant needs to provide to the user 10 to solicit the user 10 to provide additional user input 233 of information that is missing from the code script 205 in order to fulfil the routine 108 when executed by the automated assistant 200. That is, the code script evaluator 230 is configured to analyze the code script 205 and determine that the code script 205 is incomplete, and thus, the automated assistant 200 is not capable of fulfilling the routine 108 when at least one of an ambiguity is present in the code script 205, a portion of the code script 205 required for performing the routine 108 is missing, or a slot in the code script 205 lacks a fixed value. As such, the code script evaluator 230 may issue a prompt as an output instance requesting the user 10 to provide additional information needed to complete the code script 205 by enabling resolution of any ambiguities in the code script, missing portions identified in the code script, or for fixed values for slots in the code script 205 that lack fixed values. The automated assistant 200 may supplement the code script 205 with the additional information provided in the user input 133 to render completed code script 205, the completed code script 205 rendered suitable for the automated assistant to fulfill performance of the routine 108. For instance, a respective portion of the code script 205 associated with the set alarm action 110a may lack a fixed value for an “alarm time” such that the code script evaluator 230 provides the output instance 238 as a prompt to solicit the user to provide input to enable resolution of a value for the “alarm time” slot. In response, the user 10 may provide the user input 233 indicating a time of 6:00 AM’ which can be resolved to the corresponding time value within the code script 205 by the editor 234. Similarly, while the example natural language prompt 202 depicted in FIG. 1 specifies an initiator 109 (e.g., “When I Say ‘Goodnight’”) for the routine 108, the code script evaluator 230 may determine the code script 205 is incomplete when no initiator 109 is specified by the natural language prompt 202, and thus missing a portion of code script 205 required to fulfill the routine. In this scenario, the code script evaluator 230 may issue a prompt as an output instance 238 prompting the user to provide the initiator 108 for the routine 108 via user input 133. Other output instances 238 may include the code script 205, whereby the code to action converter 242 converts the respective portions of the code script in a programming language into natural language descriptions conveying the respective actions 110 which may be graphically displayed in the GUI 20 as described above with reference to FIG. 1. Another output instance 238 may include an instruction to provide the try it out feature to cause the output generating engine 240 to graphically display the graphical button 115 when the confidence score determined by the confidence scorer fails to satisfy the confidence threshold.

The code script evaluator 230 may provide the completed code script 202C for the custom routine to a routine engine 250 once the routine 108 is enabled. The routine 108 may be enabled automatically when the confidence score satisfies the confidence threshold and the code script evaluator 230 determines the code script 205 is complete, and thus, the automated assistant 200 is capable of fulfilling the routine 108 when triggered by the initiator 109. Enabling the routine 108 may further require explicit input by the user, e.g., by selecting the enable button displayed in the GUI 20 of FIG. 1. The routine engine 250 may transmit agent command(s) to one or more of the agent(s) 280, 280a-n. For example, when the routine 108 is invoked that includes a plurality of discrete actions 110 for a plurality of the agents 280, the routine engine 250 can generate and transmit agent commands to multiple of the agents 280 to cause performance of those actions. An agent command can be a structured command that includes slot value(s) in associated slots, and optionally additional data such as an indication of a domain (e.g., where the agent operates over multiple domains), a user identifier, a session identifier, etc. In some implementations, the agent command is an invocation command that invokes the selected agent. The selected agent can generate responsive content in response to the agent command. In some implementations, the responsive content is transmitted, by the selected agent to the automated assistant 200, and the output generating engine 240 generates output based on the responsive content. For example, the output generating engine 240 can provide the responsive content, unaltered, as output—or can perform a text to speech conversion (or other conversion) of the responsive content, and provide the converted content as output. In some implementations, the responsive content is transmitted, by the selected agent, directly to the client device 10. In other implementations, the selected agent may operate locally on the client device 10 (e.g., be an application installed on the client device 10), and can generate the responsive content for direct display on the client device 10. In yet other implementations, the responsive content can be transmitted to one or more peripheral devices and cause states of one or more of the peripheral devices (e.g., IoT devices) to be altered.

The automated assistant 200 communicates with each of the plurality of agents 280 via an API and/or via one or more communications channels (e.g., an internal communications channel and/or a network, such as a WAN). In some implementations, one or more of the agents 280 are each managed by a respective party that is separate from a party that manages the automated assistant 200. As used herein, an “agent” references one or more computing devices and/or software that are utilized by the automated assistant 200. In some situations, an agent can be separate from the automated assistant 200 and/or may communicate with the automated assistant 200 over one or more communication channels. In some of those situations, the automated assistant 200 may transmit, from a first network node, data (e.g., an agent command) to a second network node that implements all or aspects of the functionality of the agent. In some situations, an agent is a third-party (3P) agent, in that it is managed by a party that is separate from a party that manages the automated assistant 110. In some other situations, an agent is a first-party (1P) agent, in that it is managed by the same party that manages the automated assistant 110.

An agent 280 is configured to receive (e.g., over a network and/or via an API) an invocation request and/or other agent commands from the routine engine 250. In response to receiving an agent command, the agent generates responsive content based on the agent command, and transmits the responsive content for the provision of user interface output that is based on the responsive content and/or to control one or more peripheral devices. For example, the agent can transmit the responsive content to control one or more peripheral devices such as one or more IoT devices (e.g., smart lights, thermostats, appliances, cameras). As another example, the agent may transmit the responsive content to the automated assistant 200 for provision of output, by the automated assistant 200, that is based on the responsive content. As another example, the agent can itself provide the output. For instance, the user can interact with the automated assistant 200 via an assistant interface of the user device 10 (e.g., the automated assistant can be implemented on the user device 10 and/or in network communication with the user device 10), and the agent can be an application installed on the user device 10 or an application executable remote from the user device 10, but “streamable” on the user device 10. When the application is invoked, it can be executed by the user device 10 and/or brought to the forefront by the user device 10 (e.g., its content can take over a display of the user device 10).

Referring to FIG. 3, in some implementations, an example training process 300 trains the LLM 225 to learn how to predict code script for automated assistant routines from natural language prompts. In some examples, the LLM 225 is initially pre-trained and the training process 300 fine-tunes the pre-trained LLM 225 to learn how to predict code script for automated assistant routines. In other examples, the training process 300 trains the LLM 225 from scratch. The training process 300 may execute on the remote system 60 of FIG. 1. Accordingly, as used herein, the training performed by the training process may include both training the LLM 225 from scratch or fine-tuning the LLM 225 when the LLM is initially pre-trained.

In the example shown, the training process 300 obtains a training dataset 320 of multiple training routines 330, 330a-n stored in a training data store 310. The training data store 310 may reside on the memory hardware 64 of the remote system 60. Each training routine 330 includes a corresponding textual training natural language prompt 202T specifying a discrete set of actions for an automated assistant to perform as a routine and corresponding ground-truth code script 205T paired with the corresponding training natural language prompt 202T. One or more of the training routines 330 may also include a respective set of training user features 290T. The training user features 290T may include, without limitation, user preferences, user settings, past interactions between a user and an automated assistant, or available peripheral devices associated with the user and capable of receiving commands from the automated assistant to perform actions.

For each training routine 300, the training process 300 processes, using the LLM, the corresponding training natural language prompt 202T to generate a corresponding predicted code script 205P for the routine as output from the LLM 225, and then determines, using a loss module 350, a training loss 352 based on the corresponding predicted code script 205P and the corresponding ground-truth code script 205T paired with the corresponding training natural language prompt 202T. Based on the training losses 352 determined for the training routines 300, the training process 300 trains the LLM 225 to learn how to predict the ground-truth code scripts 205T from the corresponding training natural language prompts 205P processed by the LLM 225. For instance, the training process 300 may update parameters of the LLM 225 based on the training losses 352. In some implementations, for each training routine 330 having a corresponding set of training user features 290T, the user embedding model 295 generates a corresponding training user prompt embedding 294T such that the corresponding training natural language prompt 202T processed by the LLM 225 is conditioned on the training user prompt embedding 294T in order to improve/personalize the corresponding predicted code script 205P generated as output.

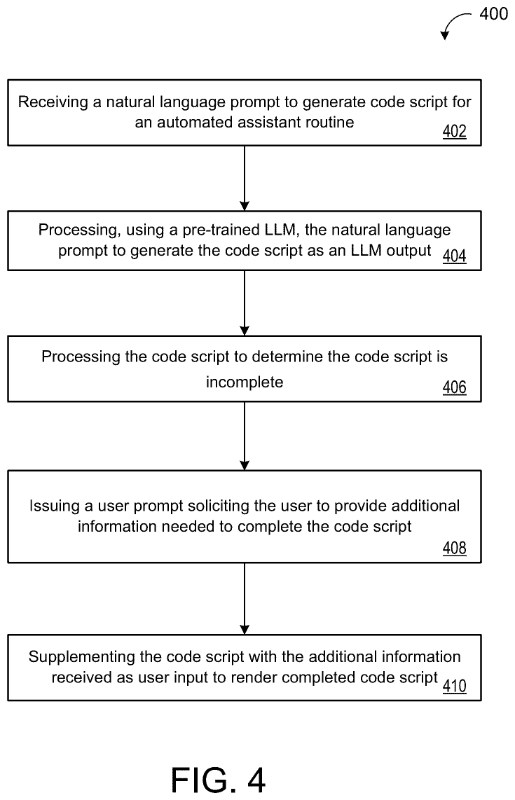

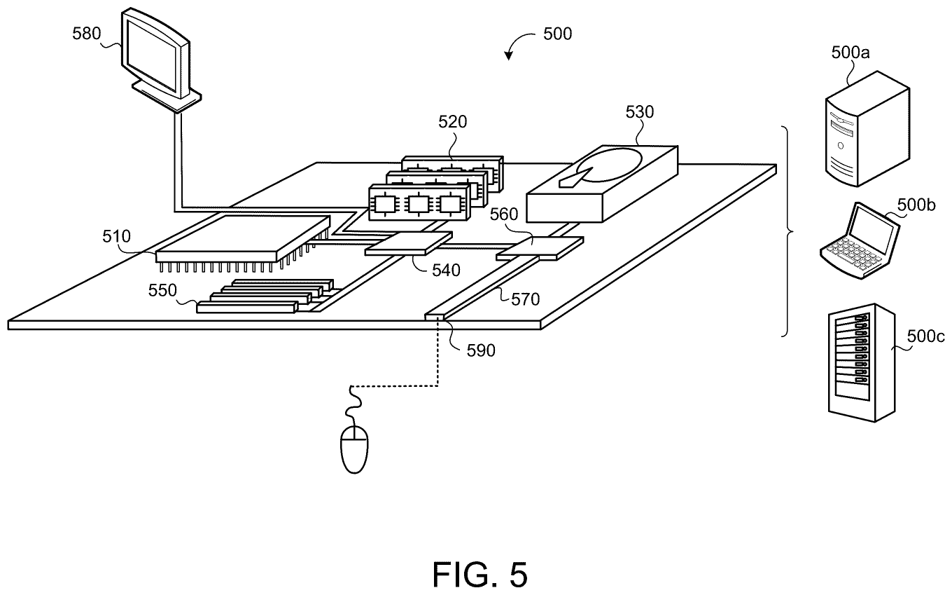

FIG. 4 is a flowchart of an example arrangement of operations for a method 400 of using a large language model (LLM) to generate code script 205 for executing an automated assistant routine based on a natural language prompt 202 input by a user 10. The method 400 may execute on data processing hardware 510 (FIG. 5) based on instructions stored on memory hardware 520 (FIG. 5) in communication with the data processing hardware 510. The data processing hardware 510 may include the data processing hardware 12 of the user device 10, the data processing hardware 62 of the remote system 60, or a combination of the data processing hardware 12, 62. Similarly, the memory hardware 520 may include the memory hardware 14 of the user device 10, the memory hardware 64 of the remote system 60, or a combination of the memory processing hardware 14, 64.

At operation 402, the method 400 includes receiving the natural language prompt 202 from the user 10 that includes a command to generate the code script 205 for an automated assistant 200 to perform a routine 108. Here, the routine 108 includes multiple discrete actions 110 specified by the natural language prompt 202. At operation 404, the method 400 includes processing, using a pre-trained LLM 225, the natural language prompt 202 to generate the code script 205 as an LLM output.

At operation 406, the method 400 includes processing the code script 205 generated by the pre-trained LLM 225 to determine the code script 205 is incomplete, thereby rendering the code script 205 unsuitable for the automated assistant 200 to fulfill performance of the routine 108. At operation 408, based on determining the code script 205 is incomplete, the method also includes issuing a user prompt soliciting the user to provide additional information needed to complete the code script and receiving user input of the additional information needed to complete the code script.

At operation 408, the method 400 also includes supplementing the code script 205 with the additional information to render completed code script 205C. Here, the completed code script 205C is rendered suitable for the automated assistant 200 to fulfill performance of the routine 108 when triggered by an initiator 109 for the routine 108.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 (e.g., the data processing hardware 10, 62 of FIG. 1) can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 (e.g., the memory hardware 14, 64 of FIG. 1) stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving a natural language prompt from a user comprising a command to generate a code script for an automated assistant to perform a routine, the routine comprising multiple discrete actions specified by the natural language prompt;
processing, by a pre-trained large language model (LLM), the natural language prompt to generate the code script as an LLM output;
processing the code script generated by the pre-trained LLM to determine the code script is incomplete, thereby rendering the code script unsuitable for the automated assistant to fulfill performance of the routine;
based on determining the code script is incomplete:
issuing a user prompt soliciting the user to provide additional information needed to complete the code script; and
receiving user input of the additional information needed to complete the code script; and
supplementing the code script with the additional information to render completed code script, the completed code script rendered suitable for the automated assistant to fulfill performance of the routine when triggered by an initiator for the routine.

2. The computer-implemented method of claim 1, wherein the operations further comprise:
processing the code script generated by the pre-trained LLM to identify the multiple discrete actions to be performed by the automated assistant to fulfill the routine; and
presenting, for output in a graphical user interface displayed on a screen of a user device associated with the user, corresponding graphical representations for the multiple discrete actions identified for the automated assistant to perform to fulfill the routine.

3. The computer-implemented method of claim 2, wherein selection of a corresponding one of the graphical representations presented for display in the graphical user interface causes the GUI to present options for editing the discrete action corresponding to the graphical representation selected by the user.

4. The computer-implemented method of claim 1, wherein:
processing the code script generated by the pre-trained LLM to determine the code script is incomplete comprises identifying a presence of an ambiguity in the code script; and
issuing the user prompt comprises issuing the user prompt to solicit the user to provide additional information to resolve the ambiguity identified in the code script.

5. The computer-implemented method of claim 1, wherein:
processing the code script generated by the pre-trained LLM to determine the code script is incomplete comprises determining that the code script includes a slot that lacks a fixed value; and
issuing the user prompt comprises issuing the user prompt to solicit the user to provide additional information that includes the fixed value for the slot in the code script that lacked the fixed value.

6. The computer-implemented method of claim 1, wherein:
processing the code script generated by the pre-trained LLM to determine the code script is incomplete comprises determining that the code script fails to convey the initiator for the routine; and
issuing the user prompt comprises issuing the user prompt to solicit the user to provide additional information that includes the initiator for the routine.

7. The computer-implemented method of claim 1, wherein issuing the user prompt comprises:
generating, using a text-to-speech engine, synthesized speech of an utterance requesting the user to provide the additional information; and
engaging a dialog with the user via the user device by instructing the user device to audibly output the synthesized speech of the utterance requesting the user to provide the additional information.

8. The computer-implemented method of claim 7, wherein receiving the user input of the additional information comprises receiving audio data characterizing the additional information spoken by the user.

9. The computer-implemented method of claim 1, wherein issuing the user prompt comprises generating a graphical representation for output from a user device associated with the user that solicits the user to provide the additional information.

10. The computer-implemented method of claim 1, wherein receiving the natural language prompt comprises receiving audio data characterizing an utterance of the natural language prompt spoken by the user.

11. The computer-implemented method of claim 1, wherein the operations further comprise:
obtaining a set of user features associated with the user; and
determining, using the set of user features associated with the user, a user prompt embedding for the user,
wherein processing the natural language prompt to generate the code script as the LLM output comprises processing, by the LLM, the natural language prompt conditioned on the user prompt embedding for the user to generate the code script as the LLM output.

12. The computer-implemented method of claim 11, wherein the set of user features associated with the user comprises at least one of:
user preferences;
past interactions between the user and the automated assistant; or
available peripheral devices associated with the user and capable of receiving commands from the automated assistant to perform actions.

13. The computer-implemented method of claim 11, wherein the user prompt embedding comprises a soft prompt configured to guide the LLM to generate the code script while parameters of the LLM are held fixed.

14. The computer-implemented method of claim 1, wherein a training process trains the LLM by:
receiving a training dataset of training routines, each training routine comprising:
a corresponding training natural language prompt specifying one or more discrete actions for an automated assistant routine; and
corresponding ground-truth code script paired with the corresponding training natural language prompt;
for each training routine in the training dataset:
processing, using the LLM, the corresponding training natural language prompt to generate a corresponding predicted code script for the routine as output from the LLM; and
determining a training loss based on the corresponding predicted code script and the corresponding ground-truth code script paired with the corresponding training natural language prompt; and
training the LLM to learn how to predict the ground-truth code scripts from the corresponding training natural language prompts based on the training losses determined for the training routines in the training dataset.

15. The computer-implemented method of claim 14, wherein:
each training routine further comprises a corresponding training user prompt embedding generated from a corresponding set of training user features; and
processing the corresponding training natural language prompt comprises processing, using the LLM, the corresponding training natural language prompt conditioned on the corresponding training user prompt embedding to generate the corresponding predicted code script for the routine as output from the LLM.

16. A system comprising:
data processing hardware; and
memory hardware in communication with the data processing hardware, the memory hardware storing instructions that when executed on the data processing hardware cause the data processing hardware to perform operations comprising:
receiving a natural language prompt from a user comprising a command to generate a code script for an automated assistant to perform a routine, the routine comprising multiple discrete actions specified by the natural language prompt;
processing, by a pre-trained large language model (LLM), the natural language prompt to generate the code script as an LLM output;
processing the code script generated by the pre-trained LLM to determine the code script is incomplete, thereby rendering the code script unsuitable for the automated assistant to fulfill performance of the routine;
based on determining the code script is incomplete:
issuing a user prompt soliciting the user to provide additional information needed to complete the code script; and
receiving user input of the additional information needed to complete the code script; and
supplementing the code script with the additional information to render completed code script, the completed code script rendered suitable for the automated assistant to fulfill performance of the routine when triggered by an initiator for the routine.

17. The system of claim 16, wherein the operations further comprise:
processing the code script generated by the pre-trained LLM to identify the multiple discrete actions to be performed by the automated assistant to fulfill the routine; and
presenting, for output in a graphical user interface displayed on a screen of a user device associated with the user, corresponding graphical representations for the multiple discrete actions identified for the automated assistant to perform to fulfill the routine.

18. The system of claim 17, wherein selection of a corresponding one of the graphical representations presented for display in the graphical user interface causes the GUI to present options for editing the discrete action corresponding to the graphical representation selected by the user.

19. The system of claim 16, wherein:
processing the code script generated by the pre-trained LLM to determine the code script is incomplete comprises identifying a presence of an ambiguity in the code script; and
issuing the user prompt comprises issuing the user prompt to solicit the user to provide additional information to resolve the ambiguity identified in the code script.

20. The system of claim 16, wherein:
processing the code script generated by the pre-trained LLM to determine the code script is incomplete comprises determining that the code script includes a slot that lacks a fixed value; and
issuing the user prompt comprises issuing the user prompt to solicit the user to provide additional information that includes the fixed value for the slot in the code script that lacked the fixed value.

21. The system of claim 16, wherein:
processing the code script generated by the pre-trained LLM to determine the code script is incomplete comprises determining that the code script fails to convey the initiator for the routine; and
issuing the user prompt comprises issuing the user prompt to solicit the user to provide additional information that includes the initiator for the routine.

22. The system of claim 16, wherein issuing the user prompt comprises:
generating, using a text-to-speech engine, synthesized speech of an utterance requesting the user to provide the additional information; and
engaging a dialog with the user via the user device by instructing the user device to audibly output the synthesized speech of the utterance requesting the user to provide the additional information.

23. The system of claim 22, wherein receiving the user input of the additional information comprises receiving audio data characterizing the additional information spoken by the user.

24. The system of claim 16, wherein issuing the user prompt comprises generating a graphical representation for output from a user device associated with the user that solicits the user to provide the additional information.

25. The system of claim 16, wherein receiving the natural language prompt comprises receiving audio data characterizing an utterance of the natural language prompt spoken by the user.

26. The system of claim 16, wherein the operations further comprise:
obtaining a set of user features associated with the user; and
determining, using the set of user features associated with the user, a user prompt embedding for the user,
wherein processing the natural language prompt to generate the code script as the LLM output comprises processing, by the LLM, the natural language prompt conditioned on the user prompt embedding for the user to generate the code script as the LLM output.

27. The system of claim 16, wherein the set of user features associated with the user comprises at least one of:
user preferences;
past interactions between the user and the automated assistant; or
available peripheral devices associated with the user and capable of receiving commands from the automated assistant to perform actions.

28. The system of claim 16, wherein the user prompt embedding comprises a soft prompt configured to guide the LLM to generate the code script while parameters of the LLM are held fixed.

29. The system of claim 16, wherein a training process trains the LLM by:
receiving a training dataset of training routines, each training routine comprising:
a corresponding training natural language prompt specifying one or more discrete actions for an automated assistant routine; and
corresponding ground-truth code script paired with the corresponding training natural language prompt;
for each training routine in the training dataset:
processing, using the LLM, the corresponding training natural language prompt to generate a corresponding predicted code script for the routine as output from the LLM; and
determining a training loss based on the corresponding predicted code script and the corresponding ground-truth code script paired with the corresponding training natural language prompt; and
training the LLM to learn how to predict the ground-truth code scripts from the corresponding training natural language prompts based on the training losses determined for the training routines in the training dataset.

30. The system of claim 29, wherein:
each training routine further comprises a corresponding training user prompt embedding generated from a corresponding set of training user features; and
processing the corresponding training natural language prompt comprises processing, using the LLM, the corresponding training natural language prompt conditioned on the corresponding training user prompt embedding to generate the corresponding predicted code script for the routine as output from the LLM.
